(19) United States
(12) Patent Application Publication
(10) Pub. No.: US 2020/0086386 A1
(43) Pub. Date: Mar. 19, 2020

(54) GOLF CLUB HEAD AND METHOD OF FABRICATION

(71) Applicants: Terry Koehler, Port O'Connor, TX (US); Scott Volk, Ithaca, NY (US)

(72) Inventors: Terry Koehler, Port O'Connor, TX (US); Scott Volk, Ithaca, NY (US)

(21) Appl. No.: 16/548,820

(22) Filed: Aug. 22, 2019

Related U.S. Application Data
(60) Provisional application No. 62/720,963, filed on Aug. 22, 2018.

(51) Int. Cl. B22F 3/105; A63B 53/04; B22F 3/11

(52) U.S. Cl. CPC B22F 3/105; A63B 53/047; B33Y 80/00; A63B 2053/0491; A63B 2053/0433; B22F 3/11

(57) ABSTRACT

A golf club head is provided that includes a club main body that includes a front portion for striking a golf ball, a rear portion, a toe portion, a heel portion and a hosel area for receiving a shaft. The club main body further includes including a first region having a first density and a second region having a second density, wherein the club main body exhibits a single monolithic metallic material throughout.

### CROSS REFERENCE TO RELATED PATENT APPLICATIONS

This patent application claims priority to Provisional U.S. Patent Application No. 62/720,963, filed Aug. 22, 2018, by co-inventors Terry Koehler and Scott Volk, the disclosure of which is incorporated herein by reference in its entirety.

### BACKGROUND

The disclosures herein relate generally to golf club head apparatus and a method of fabricating golf club head apparatus.

### BRIEF SUMMARY

In one embodiment, a golf club head is disclosed that includes a club main body that having a front portion for striking a golf ball, a rear portion, a toe portion, a heel portion and a hosel area for receiving a shaft. The club main body including a first region exhibiting a first density and a second region exhibiting a second density, wherein the club main body exhibits a single monolithic metallic material throughout.

In another embodiment, a method is disclosed that additively fabricates a golf club head to include regions of different density that are composed of a single monolithic metallic material throughout. In one embodiment, a method of fabrication includes receiving, by an information handling system (IHS), golf club head layout information that describes a particular golf club head as a plurality of layer patterns one atop the other, the plurality of layer patterns cumulatively defining a 3-dimensional design for the particular golf club head. The method also includes depositing a powdered layer of a selected metal on a surface. The method further includes patterning, by a steerable energy source controlled by the IHS, the powdered layer of selected metal by selectively heating the powdered metal layer, the steerable energy source being directed, by the IHS, at portions of the powdered layer corresponding to the pattern specified for that layer by the golf club head layout information. The method still further includes repeating the depositing and patterning steps to build-up the golf club head layer by layer to form a monolithic golf club head that exhibits the same selected metal throughout and that includes a plurality of regions exhibiting different metallic density.

### BRIEF DESCRIPTION OF THE DRAWINGS

FIG. 1A is flowchart showing high-level process flow of a method of fabricating the disclosed golf club head from a single metallic material using additive manufacturing.

FIG. 1B is a block diagram of a representative system capable of manufacturing the disclosed golf club head via direct metal laser sintering (DMLS).

FIG. 1C is flowchart showing a more detailed process flow of a method of fabricating the disclosed golf club head from a single metallic material using additive manufacturing.

FIG. 2 is a front view of representative wedge-type golf club head that includes regions of different density that are all made with the same metallic material.

FIG. 3 is a cross section of the golf club head of FIG. 2 showing an interior core spanning substantially the entire face of the golf club head.

FIG. 4 is an alternative embodiment of the disclosed wedge-type golf club head that includes regions of different density that are all made with the same metallic material.

FIG. 5 is a cross section of the golf club head of FIG. 4 showing an interior core of the golf club head of FIG. 4, the interior core being situated at the sole of the golf club head.

FIG. 6 is yet another alternative embodiment of the disclosed wedge-type golf club head that includes regions of different density that are all made with the same metallic material.

FIG. 7 is a cross section of the golf club head of FIG. 6 showing multiple regions of the gulf club head that exhibit different density, wherein one of these regions in the hosel allows desirable bending of the golf club head to allow adjustment for a particular user.

FIG. 8 is a view of the golf club head of FIG. 6 that shows more detail with respect to possible structures within the hosel region that control bending.

FIG. 9 is a cross section of the golf club head of FIG. 8 that shows more detail with respect to possible structures within the hosel region that control bending.

FIG. 10A is a cross section taken in the golf club head of FIG. 8 at or above the hosel region to show internal malleability control members above the hosel region.

FIG. 10B shows an alternative geometry for the malleability control members of the malleability enhancement region.

FIG. 10C shows the surface of the club head marked with a geometric pattern that corresponds to the fin-shaped geometry of the internal bend control structures of the golf club head of FIG. 10A.

FIG. 10D shows the surface of the club head marked with a geometric pattern that corresponds to the X-shaped geometry of the internal bend control structures of the golf club head of FIG. 10B.

FIG. 10E shows the surface of the club head marked with a geometric pattern that corresponds to the T-shaped geometry of the internal bend control structures of the golf club head.

FIG. 10F shows a representation of the disclosed golf club and its associated lie angle.

FIG. 11 is still another alternative embodiment of the disclosed golf club head that includes 3 internal regions of different density.

FIG. 12 is a cross section of the embodiment of the golf club head of FIG. 11 showing the internal regions of different density.

### DETAILED DESCRIPTION

Historically, golf club heads were commonly forged or cast in a single piece, then machined, ground, or polished to the requisite dimensions and desired aesthetic quality. As technology progressed, computer-implemented techniques were used to machine golf club heads to desired shapes and sizes. More recently, it has become common to make golf club heads of multiple materials (often dissimilar materials) and in multiple parts via welding, high-strength adhesives, and/or co-forging techniques. Some existing golf club heads are made with one or more areas that are left completely void. However, these existing techniques can be very time-consuming, difficult, and expensive when used to make golf club heads due to multiple factors such as overall volume of the club head, distribution of mass within the club head, resulting golf ball flight characteristics, and the feel and acoustics resulting from the impact of a club head with a golf ball.

Existing golf club heads are commonly made from multiple pieces that are often fabricated of different materials. Each of the materials offers different benefits to improve performance characteristics of the club heads. For example, some golf club heads are constructed using multiple materials, wherein a first material is concentrated in one portion of the club head, while the remaining portions of the club head are constructed using at least one additional material having a different density and other physical properties than the first material. The result is customization of mass properties of the club head.

There are numerous drawbacks to making golf club heads with multiple materials. First, club head designs are often constrained by the manufacturing requirements associated with using multiple materials, such as weld lines, swage geometry, adhesive bonding ledges, etc. Secondly, there are physical difficulties involved with securely connecting two dissimilar materials in a golf club head. And thirdly, the joint or seam between different materials is usually detrimental to manufacturing consistency from head to head, as well as the performance characteristics of a club head, such as malleability and hardness, or to the acoustics or sensory feel of impact with the golf ball.

Accordingly, there is a need for a method of making golf club heads that eliminates the drawbacks involved with joining dissimilar materials, while still permitting structural variations in the golf club head apparatus that allow for desired customization and improved performance characteristics.

To address these needs, a method of making golf club heads is disclosed that eliminates the drawbacks involved with joining dissimilar materials, while still permitting structural variations in the golf club heads that allow for desired customization and improved performance characteristics. The golf club heads are made from a single monolithic material and are made through additive manufacturing. The term “single monolithic material” as used in this document means that the golf club head is manufactured with the same metallic material throughout. While the golf club head may include different internal regions that exhibit different densities, or even internal regions with voids therein, the golf club head is considered to be monolithic because it is fabricated from the same metallic material throughout, such as made by the disclosed additive manufacturing process. In whatever method selected to manufacture the disclosed golf club head, the term single monolithic material refers to exactly one metallic material throughout the golf club head. In one embodiment, a single monolithic material exhibits no discrete seams or discrete junctions. The described method of manufacture enables producing a golf club head as a single monolithic metallic structure.

In an exemplary embodiment, the method for making a golf club head of a single monolithic material in an additive manner includes loading and processing information regarding the desired golf club head in a computing system. The method further includes depositing a metal powder layer-by-layer to a desired thickness. The method still further includes adjusting a material chamber corresponding to the desired thickness of a first layer of the golf club head being made. The method also includes pushing the material from the material chamber into a build chamber and creating a printed layer of the club head using a metal printer. Still further, the method includes sintering the powdered material in a specific pattern using an energy source, and lowering a platform in the material chamber to a achieve a desired thickness and specific geometry for a second layer of the golf club head.

The method allows for manipulation of any chosen starting material through additive manufacturing to create any desired material density and/or porosity in any desired position of a club head. The finished club heads may comprise a plurality of areas, each having different densities. The density for each area may vary from zero to nearly 100% dense.

Particular areas or regions in each fabricated club head may be engineered to allow increased malleability and/or hardness to achieve desired post-production performance and characteristics. In an exemplary embodiment, an engineered, internal structure within the hosel area of the club head may allow for bending of the hosel to various lie angles, while being resistant to bending in an undesirable manner.

Generally, the subject matter disclosed herein relates to a method for making golf club heads from a single material using an additive manufacturing process. Specifically, the golf club heads are made from a single monolithic material using an additive manufacturing process to create finished golf club heads, such as irons, woods, putters, wedges, utility clubs, and the like, having a plurality of areas, wherein at least two of the areas have different physical properties.

The additive manufacturing process disclosed herein allows for the creation of a plurality of areas in a golf club head having desired physical properties. The plurality of areas in the golf club head may each have a varying shape, location, material density, porosity, engineering structure, and/or other physical properties. The result is the fabrication of the golf club head as a single monolithic piece, wherein there is a seamless material transition from a plurality of different regions having varying, customized physical properties. Thus, there is no need for welding or other methods of joining two or more dissimilar materials into a single golf club head.

By using a single monolithic material in the construction of golf club heads, a variety of different desired physical properties may be integrated into a single golf club head to tailor the material property distribution in the club head. Specifically, the shape, location, material density, porosity, and/or other physical properties may be varied within different areas of the golf club head to readily improve the performance of the golf club head compared with current fabrication techniques. There are various ways to improve the performance of the club head or its aesthetic quality to include sensory feedback and acoustics of the strike of a golf ball, such as, but not limited to, weight or mass placement for optimizing center of gravity and moment of inertia, malleability for bending, hardness or elasticity for ball-striking optimization, sensory and acoustical feedback or any combinations thereof.

The additive manufacturing process disclosed herein for making golf club heads may involve an additive metal process, such as DMLS. DMLS involves the use of a DMLS system having a build chamber, a material chamber, a recoater, and an energy source, such as one or more lasers. The recoater may push powdered material from the material chamber into the build chamber, and the energy source may generate (e.g., melt) a pattern in the powder to produce layers of solidified material forming the component.

The build chamber may be configured to house and support one or more golf club heads during its fabrication. The build chamber is formed by a plurality of connected walls and a moveable stage. The material chamber also includes a plurality of connected walls surrounding a supply of powdered material used to manufacture the golf club head, a platform, and one or more actuators connected to the bottom of the platform.

The recoater is an elongated blade or arm that is moveable across openings formed inside of the connected walls. The recoater is configured to move the powdered material in a single direction over an earlier fabricated layer of a portion of the golf club head.

The lasers are configured to generate one or more beams of energy directed onto the layer of powdered material after deposition by the recoater. The beams of energy are capable of heating the powdered material to a level sufficient to sinter (i.e., to coalesce the powdered material into a porous state) or otherwise harden the powdered material. In some embodiments, various optics (e.g., lenses, mirrors, gratings, filters, etc.) may be used to focus, redirect, and/or align beams of energy with a desired pattern on the powdered material, thereby generating a required shape and contour of the golf club head corresponding to a height of the layer currently being manufactured. Energy sources, other than lasers (e.g., ultraviolet light sources, electromagnetic energy sources, chemical energy sources, etc.) could alternatively be used to sinter or harden the material. Forming each layer of the golf club head in the above described manner may also be referred to a “patterning”.

A number of commercially available systems are suitable for use in the subject matter disclosed herein. For example, the Renishaw AM 400, EOS M280/290/400, and 3D Systems Prox 320 systems available from Incodema3D, LLC can create components from any number of metals including the following powders: zinc, bronze, stainless steel, titanium, cobalt-chrome, silicon carbine, nickel alloys, and aluminum oxide. The Renishaw AM 400, EOS M280/290/400, and 3D Systems Prox 320 systems may be capable of manufacturing golf club heads with increased accuracy, efficiency, and/or profitability, by reducing component rejection and waste.

In some examples, the method for making golf club heads using additive manufacturing includes processes, such as Binder Jetting. The Binder Jetting process may include a powder-based material and a binder. The binder is usually in liquid form and the build material is commonly in powder form. A print head moves horizontally along the X and Y axes of an additive manufacturing machine and deposits alternating layers of the build material and the binding material.

Another exemplary material extrusion process that may be used herein includes fuse deposition modeling (FDM). FDM involves material being drawn through a nozzle, heated, and then deposited layer-by-layer. The nozzle may move horizontally and a platform may move vertically after each new layer is deposited.

A Powder Bed Fusion process may be used herein. The Powder Bed Fusion process includes exemplary printing techniques, such as Direct Metal Laser Sintering (DMLS), Electron Beam Melting (EMB), Selective Heat Sintering (SHS), Selective Laser Melting (SLM), and Selective Laser Sintering (SLS). In some examples, Directed Energy Deposition (DED) is used herein as a printing process to repair or add additional material to existing components.

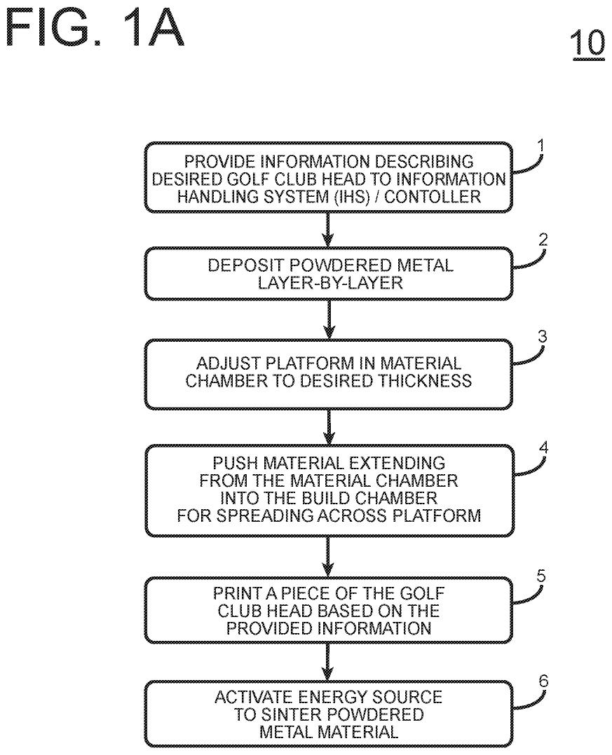

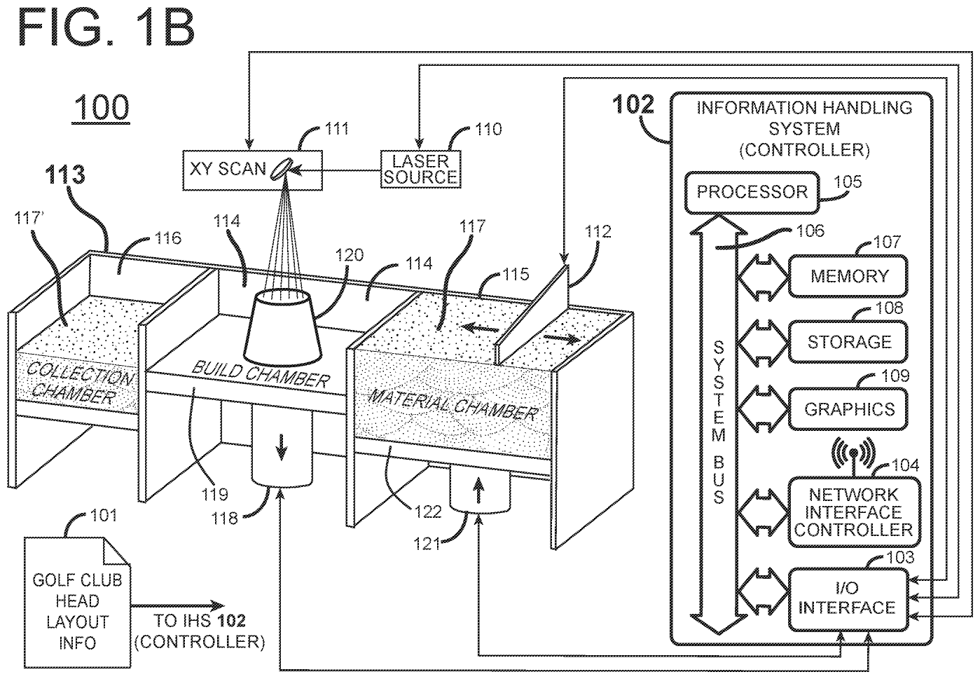

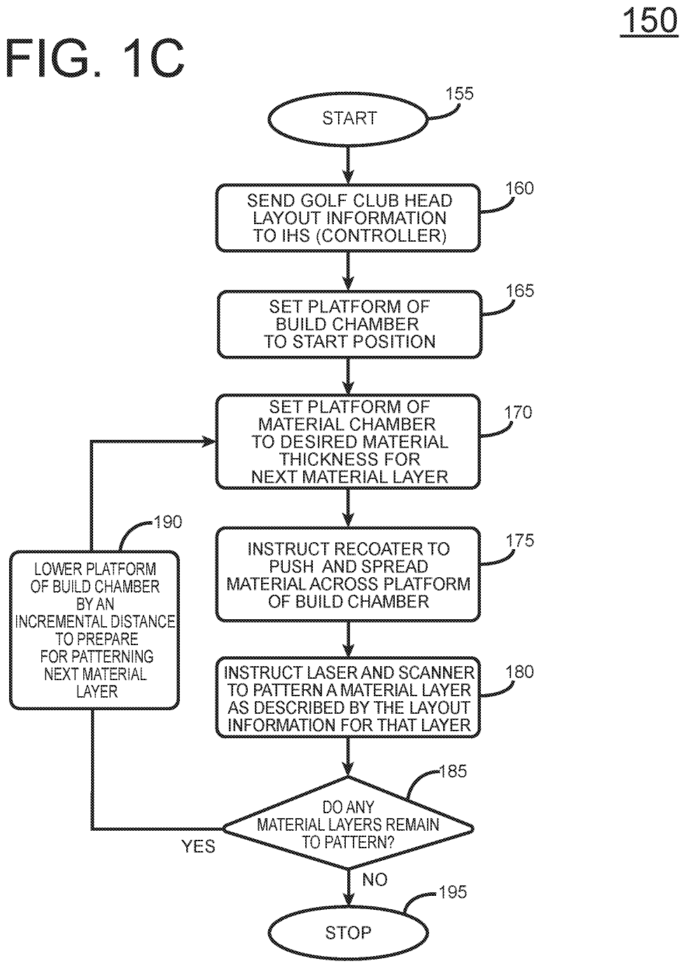

FIG. 1A is a high level flowchart that shows an exemplary method 10 for making a golf club head of a single monolithic material in an additive manner. First, as shown in block 1, information regarding the desired golf club head is loaded into a computing system including any type of computing hardware and software used to design a golf club head through additive manufacturing. The computing system may include one or more computers loaded with computer aided design (CAD) programs. The programs may be used to load, create, or modify a three-dimensional (3D) definition of a desired component. A user may input a design from a CAD file to reflect the user's cosmetic, engineering, and performance goals a particular golf club head.

The information regarding the desired golf club head involves a selection of a set of design parameters to deliver a desired set of cosmetic, engineering, and performance parameters for the golf club head. The design parameters may include, but are not limited to: exterior shaping, interior shaping, density, weight, distribution, bounce angle, lie angle, offset, loft angle, hardness, malleability, sole camber, sole width, cavity undercut, center of gravity, face height, hosel diameter, hosel depth, toe height, groove depth, groove width, or combinations thereof.

Next, as shown in block 2, a powdered metal of a desired thickness is deposited layer-by-layer during the construction of a golf club head. The platform in the material chamber is then adjusted (either lowered or raised) in an amount corresponding to a desired thickness of a first layer of the golf club head being fabricated, as shown in block 3. Next, as shown in block 4, the recoater pushes the material extending from the material chamber into the build chamber where the material is spread across the platform in a consistent and well-distributed manner.

As shown in block 5, a metal printer, in communication with the computing system, creates a printed piece of the club head based on the information provided. The metal printer may be configured to manufacture metal pieces from the powdered metal. The metal printer may include a computer-controlled energy source that sinters or melts the powdered material.

As shown in block 6, the energy source is then activated to sinter the powdered material in a pattern according to the exterior shaping, interior shaping, density, weight, distribution, bounce angle, lie angle, offset, loft angle, hardness, malleability, sole camber, sole width, cavity undercut, center of gravity, face height, hosel diameter, hosel depth, toe height, groove depth, and groove width of the golf club head. In some embodiments, the energy source is a laser, such as an Excimer laser, a Yb:tungstate laser, a CO2 laser, a Nd:YAG laser, a DPSS laser, or another type of laser known in the art) that are configured to generate one or more beams of energy directed onto the layer of powdered material after deposition by the recoater. The energy source may vary the density of golf club heads through the use of variable energy density.

The platform is then lowered by a distance corresponding to a thickness of a second layer of the golf club head and the method 10 disclosed above is repeated. After the completion of the golf club head, the platform may be raised up, relative to the walls, such that the golf club head is accessible to a user. Any powdered material that has not been sintered may then be removed from around or inside the golf club head, or even left inside the golf club head.

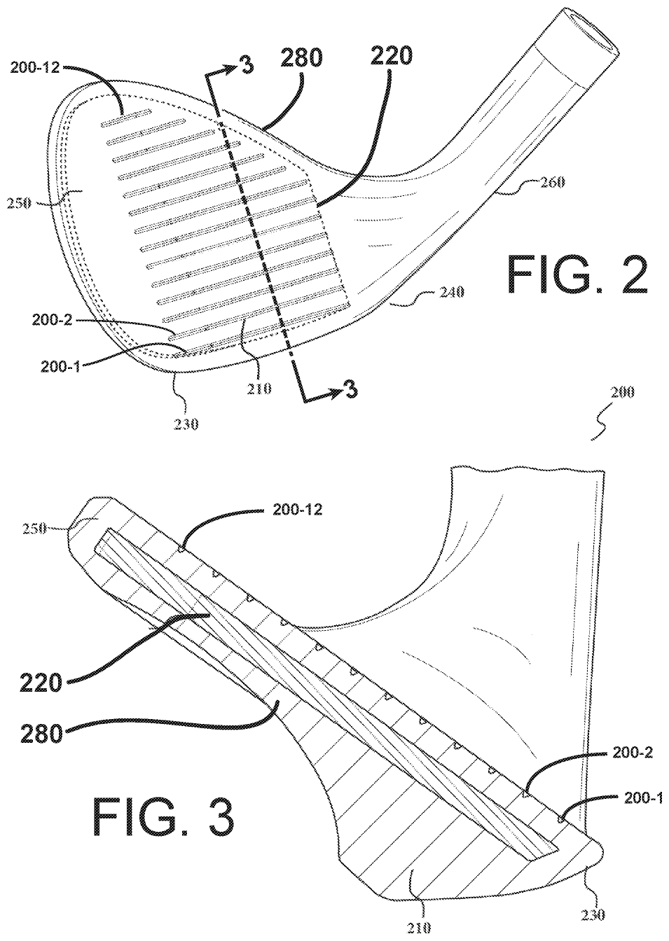

The disclosed method may be used for making various types and configurations of golf club heads, such as shown in FIGS. 2-12 that are discussed below.

FIG. 1B is a representation of a system 100 that may be employed to manufacture the disclosed golf club head via additive manufacturing. This particular system employs direct metal laser sintering (DMLS), however it should be understood that other systems using additive manufacturing may be employed as well. The user of system 100 inputs a golf club head layout information file 101 to system 100. The golf club head layout information file 101 includes information that describes the desired golf club head geometry layer by layer. More particularly, the layout information for each layer describes the desired pattern for the metallic structures of that particular layer.

The golf club head layout information file 101 is received by the I/O interface 103 of information handling system (IHS)/controller 202. Alternatively, the golf club head layout information file 201 is received by network interface controller 204 either wirelessly or via wire. IHS/controller 102 includes a processor 205 that couples via system bus 106 to system memory 107, permanent storage 208, a graphics unit (which may couple to a user display, not shown), network interface controller 104 and I/O interface 103.

Using I/O interface 103, IHS/controller 102 couples to a laser source 110, an X-Y scanner 111 and a recoater 112 of a direct metal laser sintering (DMLS) machine 113. DMLS) machine 113 includes a build chamber 114, a material chamber 115 and a collection chamber 116. Material chamber 115 is filled with the metallic powder 117 from which the desired golf club head is manufactured under the control of IHS/controller 102. Build chamber 114 includes a piston 118 attached to a platform 219 that IHS/controller 102 incrementally lowers by a step amount corresponding to the thickness of each layer of the workpiece 120, namely a golf club head or an array of golf club heads. Material chamber 115 includes a piston 121 attached to platform 121 that IHS/controller 102 incrementally raises by a incrementally to allow recoater 112 to sweep the next layer of metallic powder 117 into build chamber 114 for laser sintering according to the pattern specified for that particular layer.

To allow workpiece 120 to be seen in FIG. 1B, build chamber 114 is illustrated without any materiel therein. Those skilled in the art will understand that in actual practice build chamber 114 is filled with metallic powder provided by recoater 112 that sweeps metallic powder 117 into build chamber 214 as each layer is formed by laser sintering. Workpiece 120 (namely a golf club head) is thus built up layer by layer by the disclosed process wherein IHS/controller 102 controls piston 121 and recoater 112 at material chamber 115 to provide metallic powder 117 to build chamber 114. Moreover, IHS/controller 102 controls piston 118, laser source 110 and X-Y scanner 111 to sinter the metallic pattern corresponding to that layer as specified by the golf club layout information file 101. Collection chamber 116 receives excess metallic powder 117′ for recycling.

FIG. 1C is an alternative more detailed overview of the disclosed DMLS manufacturing process 150. Process flow commences at start block 155. The user sends a golf club layout information file to IHS/controller 102, as per block 160. The golf club head layout information file contains design information precisely describing the pattern of each of the layers of the golf club head that cumulatively form the golf club head to be manufactured. IHS/controller 102 sets the piston/platform of the material chamber 115 to the desired starting height for the first layer (i.e. the lowermost layer) of the golf club head to be printed, as per block 165. Subsequently, IHS/controller 102 sets the platform of the material build chamber 114 to the desired starting height for the first layer (i.e. the lowermost layer) of the golf club head to be printed, as per block 170. IHS/controller 102 instructs recoater 112 to push and spread metallic powder from material chamber 115 across platform 119 of build chamber according to the thickness specified for the current layer (namely the first layer in this example), as per block 175.

To pattern the current layer, IHS/controller 102 instructs laser 110 and XY scanner 111 to pattern the metallic powder layer to the pattern described in the layout information for the current layer. Subsequently, IHS/controller 102 conducts a test to determine if any layers remain to be patterned, as per decision block 185. If more layers remain to be patterned, then IHS/controller 102 communicates with piston/platform 118 to lower the platform of build chamber 114 by an incremental distance to prepare for patterning the next layer of metallic powder, as per block 190. Process flow then continues to block 170 and the process repeats until decision block 185 determines that no more layers remain to be patterned, as per decision block 185. When no more layers remain to be patterned, process flow continues to stop block 195 and the process 150 ends.

FIG. 2 shows a front view of a wedge type club head 200 fabricated from a single monolithic material using the method 100 shown in FIG. 1, wherein the club head 200 has a plurality of areas with different densities. The club head 200 includes a ball-striking face 210, an interior core 220 (as shown in FIGS. 2 and 3) behind the face 210, a sole 230, a heel 240, a toe/topline 250, a hosel 260, and an outer shell 280. In some embodiments, the face 210 includes a plurality of parallel, spaced apart score lines, such as score lines 200-1, 200-2 and 200-12 that are formed in the surface of the face 210. In some embodiments, the face 210 is configured to display a specified texture across all or a portion of the surface of the face 210.

In the embodiment shown in FIG. 2, the club head 200 is made of cobalt-chrome. In other embodiments, the club head 200 may be made of other single monolithic materials, such as zinc, bronze, stainless steel, titanium, silicon carbine, and aluminum oxide. Specifically, the club head 200 may include powdered metals, such as cobalt-chrome, 15-5 stainless steel, 17-4 stainless steel, Inconel 5 625, Inconel 718, and Titanium 64. It is conceived that other desirable materials or material blends may be used herein.

The method 10 shown in FIG. 1 allows for the ability to control the average density of the club head 200 by varying the density of certain areas of the club head 200. Varying the density of specific areas of the club head 200 allows for the distribution of mass throughout the club head 200 to control the physical and performance characteristics of the club head 200, such as the malleability and hardness, the golf ball performance, or the acoustics and sensory feel of impact with the golf ball. Density control may be accomplished in a variety of ways.

The interior core 220 may be manufactured to yield a density that is either greater or less than the density of the rest of the club head 200 to allow precise management of mass distribution in the club head 200. In some examples of the club head 200 of FIG. 2, the sintered interior core 220 has a density from about 2.3 g/cm³ to about 5.7 g/cm³ and the density of the outer shell 280 is about 8.3 g/cm³. Thus, the embodiment of FIGS. 2 and 3 provides a golf club head 200 that includes an outer shell 280 exhibiting one density and an interior core 220 of that exhibits another density.

FIG. 3 shows a cross-sectional view of the club head 200 of FIG. 2, illustrating the interior core 220 spanning substantially the entire face 210 of the club head 200. In the exemplary embodiment of FIG. 3, the constant density value for the interior core 220 is set at about 5.7 g/cm³ to achieve a specified weight for the club head 200 when the interior core 220 has a thickness of about 0.090 inches and each of the face 210, the sole 230, and the topline 250 has a thickness of about 0.100 inches. In this embodiment, the mass of the interior core 220 is about 38 grams and the mass of the outer shell 280 is about 257 grams. The hosel 260 is completely sintered in this embodiment.

In other exemplary golf club heads, the interior core 220 is (i) less dense than 5.7 g/cm³; (ii) positioned only behind the score lines (i.e. hitting area); and/or (iii) positioned at the sole or as close as possible to the sole. In some of the exemplary club heads, the interior core 220 has a greater thickness than 0.090 inches.

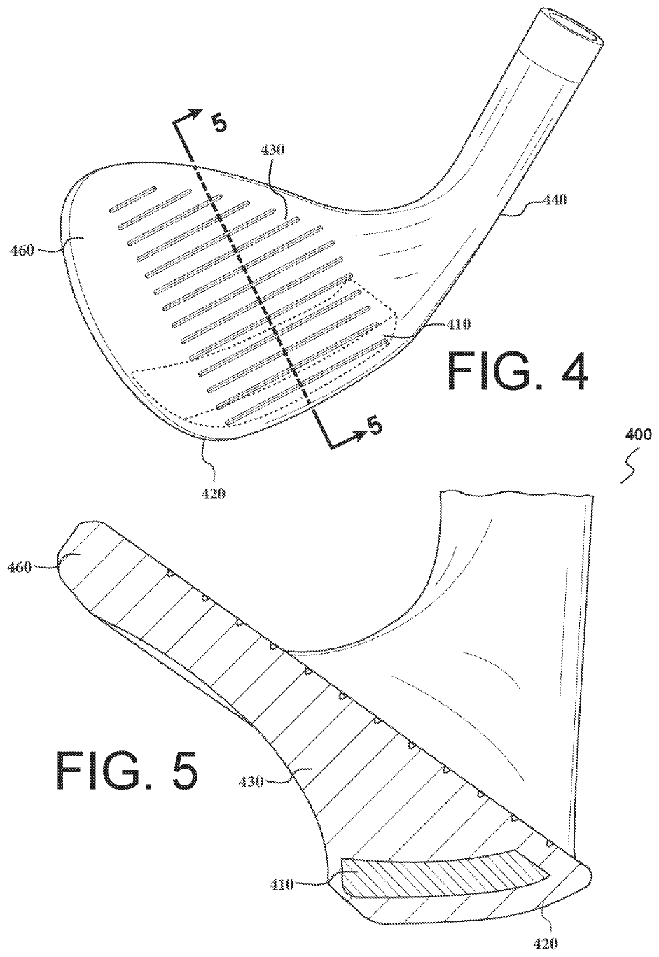

For example, FIG. 4 shows a front view of another exemplary wedge type club head 400 fabricated from a single monolithic material (e.g. cobalt-chrome) using the method 10 shown in FIG. 1, wherein the club head 400 includes a plurality of areas or regions with different densities. The club head includes a sole 420, a ball-striking face 430, a hosel 440, a toe/topline 460, and a lower interior core 410 that is positioned across the sole 420. FIG. 4 shows lower interior core 420 using dashed lines to indicate this region is interior to golf club head 400. The interior core 410 exhibits a sintered density of only about 2.3 g/cm³ to create the highest possible center of gravity in the vertical orientation of the club head 400.

FIG. 5 is a cross section of golf club head 400 of FIG. 4 taken along section line 5-5. As shown in FIG. 5, the thickness of the interior core 410 is about 0.125 inches, while the thickness of each of the face 430 and the sole 420 is about 0.100 inches.

In other exemplary golf club heads made using the method of FIG. 1, the interior core may include one or more areas and may be completely void of any material, regardless of where it is positioned on the club head. This allows mass to be removed from the interior core and be repositioned in different areas throughout the club head for improved mass distribution.

In yet other exemplary golf club heads made using the method of FIG. 1, the interior core may be filled with raw powder material that is not sintered via laser printing such as DMLS. In these club heads, the raw material may be cobalt-chrome powder 5 and may exhibit a density of about 4.6 g/cm³. The raw material may provide a vibration-dampening effect to improve the sensation of impact with a golf ball and may improve the acoustics of golf ball impact upon the club head. In this embodiment, the area of raw powder material may be evacuated after production, and the void left unfilled, or re-filled with a polymer or other injectable compound to further improve acoustics or the sensory feel of the impact of the golf ball on the club head.

In addition to being positioned behind the score lines of the face, the interior core may extend to the perimeters of the club head, such as the topline and the sole. In addition to the various density distributions noted above, the density in a club head may be distributed in a variety of ways and areas to achieve desired results. A golf club head 400 is thus provided that includes regions of different density, namely an interior core 410 that exhibits one density, while the remainder of the golf club head exhibits another density to form a single monolithic structure that is fabricated entirely from the same metallic material.

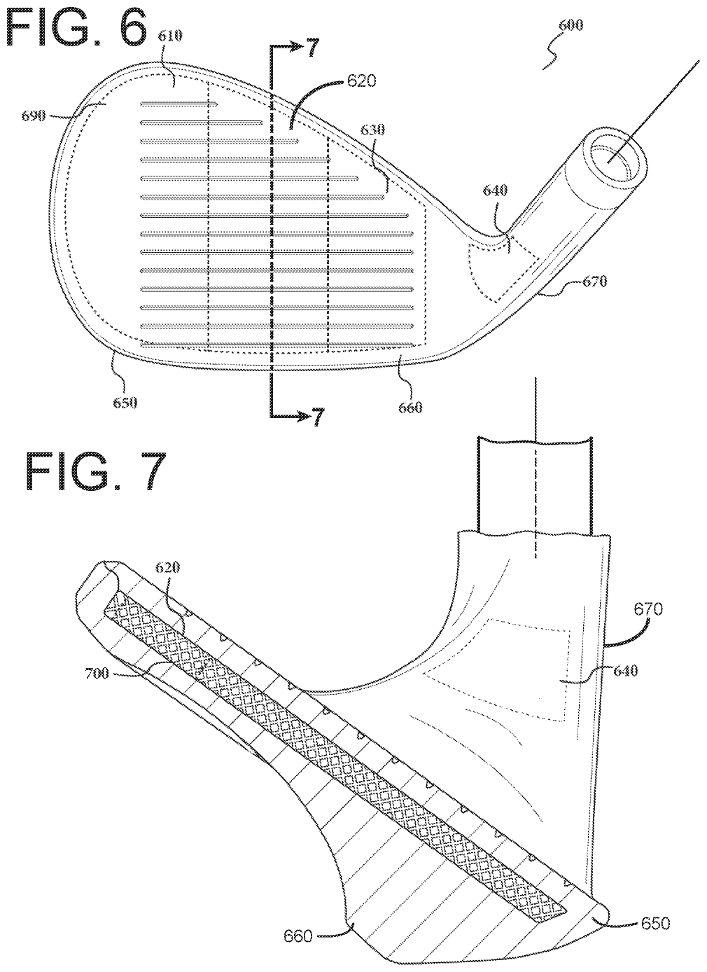

FIG. 6 shows a front view of another wedge type golf club head 600 fabricated as a single monolithic material using method 10 of FIG. 1, wherein the club head 600 includes at least four regions (610, 620, 630, and 640), each exhibiting different a different density. The club head 600 also includes a sole 650, a ball-striking face 660, a hosel 670, and a toe/topline 690.

Different density regions 610, 620, 630, and 640 may range from being void of any material, to being filled with raw material, and to being sintered at various densities, such as between about 2.3 g/cm³ to about 5.7 g/cm³. As shown in in FIG. 6, the internal regions 610, 620, 630 are situated along the face 660, while hosel region 640 is situated within the hosel 670. In this embodiment, the area of raw powder material may be evacuated after production, and the void left unfilled, or re-filled with a polymer or other injectable compound to further improve acoustics or the sensory feel of the impact of the golf ball on the club head.

FIG. 7 is a cross section of golf club head 600 of FIG. 6 taken along section line 7-7. Since section line 7-7 of FIG. 6 is taken complexly through region 620, region 620 is visible in the cross section shown in FIG. 7, whereas adjacent neighboring regions 610 and 630 are not visible. Internal hosel region 640 is visible in in FIG. 7 as indicated by corresponding dashed lines.

In one embodiment, the internal regions 610, 620, 630 and 640 may be implemented as an engineered structural matrix 700 (as shown in FIG. 7) of various designs in order to provide reduced mass, while offering structural support and/or acoustical benefit to the club head. The designs of the structural matrix allow for complete control of the mass of the interior core based on its desired positioning on the club head and thickness. As shown in FIG. 7 in which internal region 620 is visible in cross section, the region 620 exhibits such a structural matrix 700 having a lattice design. The lattice design is made up of arrays of slender members that vary in size from microns to millimeters. It may have a cubic-shape or any other shape that provides the desired functional properties to the club head 600, such as improved sensory feedback and acoustics, malleability for bending, and hardness or elasticity for ball-striking optimization. The lattice design allows for the structural matrix 700 to be self-supporting to minimize the need for sacrificial support and reduce waste.

In other examples, the structural matrix 700 is positioned at internal region 640 within the hosel 670. This allows for bending of the hosel 670 in only one or two directions to allow adjustment of loft and lie angles for customization to various golfers, as described in more detail below. In yet other examples, the structural matrix 700 may be positioned in some or all of the areas 610-640. This structural matrix 700 may allow for target densities less than the densities of the raw material powder, but more than the densities of a complete void.

In other embodiments, a club head may have two, three, four, or more than four areas exhibit different densities. Each of the different areas may be manufactured using the method of FIG. 1 to have different densities to further manipulate the distribution of mass. In other embodiments, golf club heads may be fabricated from multiple, different materials using additive manufacturing.

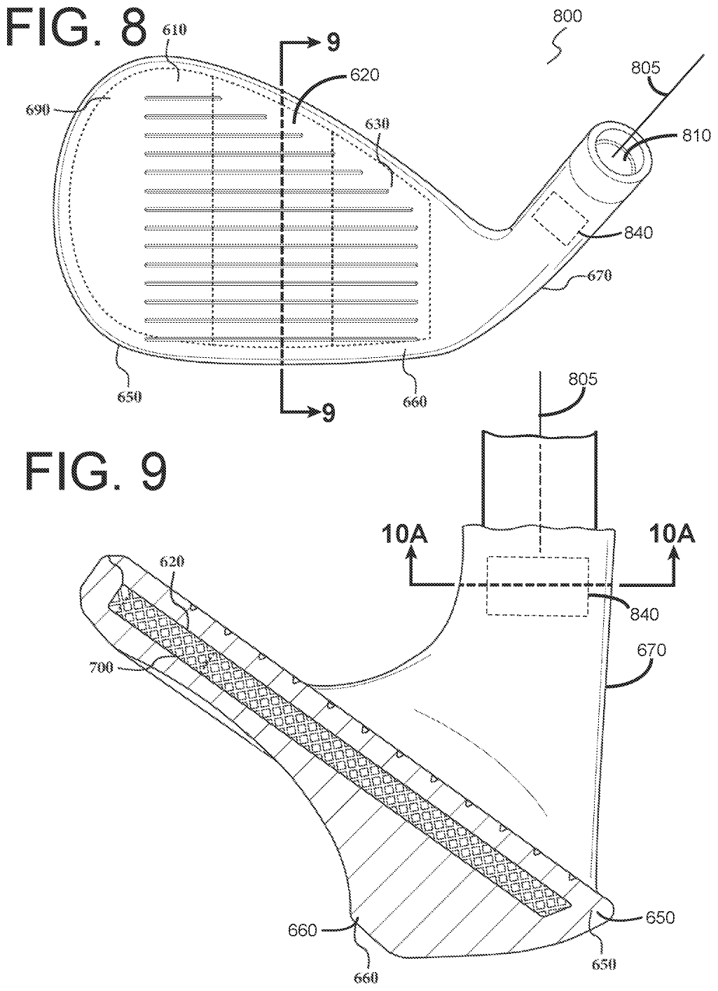

FIG. 8 shows an example a special internal region 840 structure that is engineered to allow increased malleability and/or hardness to achieve desired post-production performance and characteristics. Golf club head 800 of FIG. 8 is similar to golf club head 600 of FIG. 6 with like reference numbers being used to indicate like elements. In an exemplary embodiment, an engineered, internal malleability enhancement region (MER) 840 above the wide portion of hosel 670 of club head 800 of FIG. 8 may allow for easier bending of the club head 800 to various lie angles, while being resistant to bending in an undesirable manner.

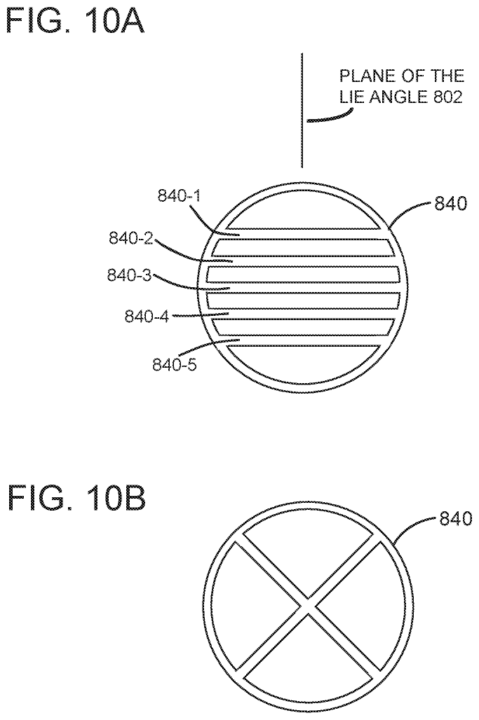

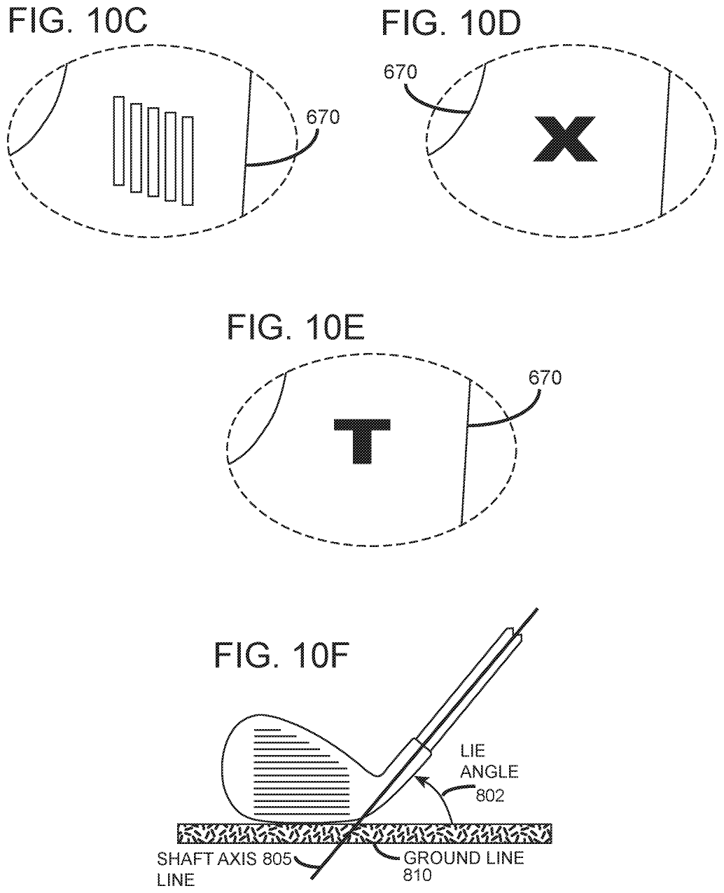

Bending of the golf club hosel 670 is sometimes desirable to calibrate the lie angle of the golf club for a particular golfer. FIG. 10F shows the lie angle 802 as being the angle that the shaft axis line 805 of the golf club forms with respect to the ground line 810, as illustrated. Returning to. FIG. 8, while bending the club head adjacent and above hosel 670 may be desirable, such bending can be very difficult to perform when the golf club head is fabricated from high strength durable materials such as cobalt-chrome. To achieve bending of such high strength materials, golf club head 800 includes a special “malleability enhancement region” (MER) 840. MER 840 is the aforementioned engineered, internal hosel structural region of increased malleability. In one embodiment, MER 840 provides greater ease of bending in all directions as compared with a golf club head without MER 840. In another embodiment, MER 840 provides increased ease of bending (i.e. less resistance to bending) in one direction while providing more resistance to bending in another direction.

FIG. 9 show the taking of a cross section along section line 10A-10A to enable the viewing of a cross section of a representative MER 840 above the hosel 670 and below the bore that receives the shaft For example, as shown in FIG. 10A, MER 640 may be an open region that includes a plurality of parallel, spaced-apart malleability control members such as malleability control members 840-1, 840-2, 840-3, 840-4 and 840-5. In one embodiment, MER 640 is a small region exhibiting a length of approximately ½ inch to approximately ¾ inch as measured in the direction of shaft axis line 805. Depending on the particular application, MER 640 may exhibit larger or smaller dimensions. However, MER 640 should not be dimensioned so large that it significantly reduces the structural integrity of hosel 670 and/or the region of the club above the hosel. To bend MER 840 in either direction along the plane of the lie angle, the MER region of the golf club head may be clamped in a loft and lie machine by a professional highly skilled in bending golf club heads. A bending bar tool may be used to the MER region in either direction by a range of approximately 1 to approximately 3 degrees or more if desired. One reason that providing golf club head 800 with an MER 840 allows easier bending is because the golf club head adjustment professional is effectively bending against less metal as compared with a hosel without a special MER 640. The density of MER 840 is significantly less than the density of other regions of golf club head 800.

FIG. 10A is a cross section of hosel 670 taken along section line 10A-10A of FIG. 9. FIG. 10A provides more detail with respect to one representative configuration of malleability enhancement region (MER) 640. More specifically, FIG. 10A shows MER as including parallel, spaced-apart malleability control members 640-1, 640-2, 640-3, 640-4 and 640-5. These members exhibit a fin-like geometry wherein the fins are aligned to make bending of the club head easier in the plane of the lie angle 820, as referenced in FIG. 10A. In one embodiment, if a golf club head alignment professional were to look downward into the bore below the shaft, the illustrated fins may be oriented perpendicular to the lie angle to provide easier bending in either direction along the plane of the lie angle. While MER 840 provides less resistance to bending in directions along the plane of the lie angle, it provides more resistance to bending in other directions not along the plane of the lie angle. This desirable effect may be called preferential bending. While MER 840 provides desirable preferential direction bending of golf club head 800, it also decreases the likelihood that golf club head 800 will break while bending in a loft and lie machine.

FIG. 10B shows an alternative embodiment of MER 840 wherein the malleability control members exhibit an X-shaped geometry. Other MER geometries are also possible, such as a T-shaped geometry, for example.

When the user views the hosel 670 of disclosed golf club head, there may be no externally visible indication of the special MER 640 within the hosel. Using the same DMLS process described in method 150 of FIG. 1C, or through engraving, stamping or other marking process, an external MER indicator may be manufactured at the external hosel surface or on the surface of the club head above MER 840. The geometry selected for the external MER indicator may correspond to the geometry of the internal MER within to the club head 800. For example, to signify that the hosel includes a special MER, a graphic representation of the respective internal geometry of the MER is formed on the external surface of the MER. More specifically, FIGS. 10C, 10D and 10E show club head 800 marked with external markings showing fins, X-shapes and T shapes, respectively to indicate the internal geometries of the corresponding MERs 640.

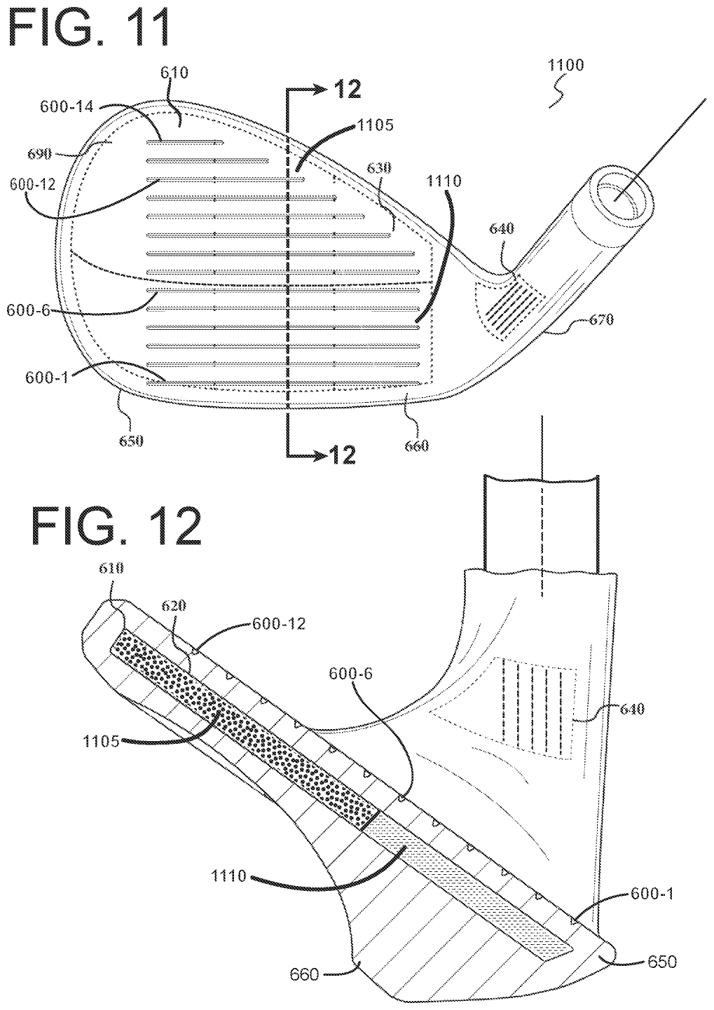

FIGS. 11 and 12 show a golf club head 1100 that is configured with regions of different density that reduce transmitted vibrations from being transmitted up through the hosel and shaft to the golfer when the golfer hits the golf ball with the club head. This feature can be especially desirable in golf club heads made of high durability materials such as cobalt-chrome that otherwise may transmit substantial vibrations up the shaft to the user giving the golf club a very harsh feel. Golf club head 1100 includes a number of structures in common with golf club head 800 of FIG. 8. Like numbers indicate like elements when comparing golf club head 1100 of FIG. 11 with golf club head 800 of FIG. 8.

As seen in FIG. 11, golf club head 110 includes a region of first density 1105 and an immediately adjacent region of second density 1110. Together, first and second density regions 1105 and 1110 provide shock dampening, i.e. vibration dissipation, to golf club head 1100. FIG. 12 is a cross section of golf club head 1100 taken along section line 12-12 of FIG. 11. As seen in FIG. 12, both region of first density 1005 and region of second density 1110 are situated in the same plane internal to golf club head 1100. Regions 1105 and 1110 are situated behind the face of the golf club head. Both regions 1105 and 1110 are regions of reduced density compared with other structures of the single metal monolithic golf head 1100. This configuration of reduced density structures internal to golf club head 1100 have been found to dissipate the vibrations of ball impact before those vibrations travel through hosel 670 up to the shaft. In this manner, golf club head 1100 can be manufactured with extremely hard, wear-resistant, abrasion-resistant monolithic metal such that ball impact does not feel harsh to the golfer.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A golf club head, comprising:
a club main body that includes a front portion for striking a golf ball, a rear portion, a toe portion, a heel portion and a hosel area for receiving a shaft;
the club main body further including a first region exhibiting a first density and a second region exhibiting a second density, wherein the club main body exhibits a single monolithic metallic material throughout.

2. The golf club head of claim 1, wherein the first region exhibiting a first density and the second region exhibiting second density are situated internal to the golf club head behind the front portion and adjacent one another to form a vibration dissipating structure internal to the golf club head.

3. The golf club head of claim 1, wherein the club main body includes a third region exhibiting a third density.

4. The golf club head of claim 1, wherein at least one of the first, second and third regions exhibits a density of approximately zero to provide a void interior to the club main body.

5. The golf club head of claim 1, wherein the second region exhibiting second density is a malleability enhancement region (MER) situated a hosel region of the golf club head, the density of the MER being less that the density of other parts of the hosel region such that the MER exhibits more malleability than other parts of the hosel region.

6. The golf club head of claim 5, wherein the malleability enhancement region (MER) exhibits bendability in a first direction in the plane of the lie angle for the golf club head while resisting bending in second directions other than the plane of the lie angle.

7. The golf club head of claim 6, wherein the malleability enhancement region (MER) includes a plurality of parallel spaced-apart malleability control members internal to the hosel region.

8. The golf club head of claim 7, wherein the plurality of parallel spaced-apart malleability control members exhibit a fin-shaped pattern.

9. The golf club head of claim 7, wherein the plurality of parallel spaced-apart malleability control members exhibit an X-shaped pattern.

10. The golf club head of claim 7, wherein the plurality of parallel spaced-apart malleability control members exhibit a T-shaped pattern.

11. A method of golf club head fabrication, comprising:
receiving, by an information handling system (IHS), golf club head layout information that describes a particular golf club head as a plurality of layer patterns one atop the other, the plurality of layer patterns cumulatively defining a 3-dimensional design for the particular golf club head;
depositing a powdered layer of a selected metal on a surface;
patterning, by a steerable energy source controlled by the IHS, the powdered layer of selected metal by selectively heating the powdered metal layer, the steerable energy source being directed, by the IHS, at portions of the powdered layer corresponding to the pattern specified for that layer by the golf club head layout information; and
repeating the depositing and patterning steps to build-up the golf club head layer by layer to form a monolithic golf club head that exhibits the same selected metal throughout and that includes a plurality of regions exhibiting different metallic density.

12. The method of golf club head fabrication of claim 11, wherein at least one of the regions exhibits a metallic density of approximately zero to form a void in the particular golf club head for that region.

13. The method of golf club head fabrication of claim 11, wherein at least one of the regions of the plurality of regions exhibits a porosity different from the porosity of another region of the plurality of regions.

14. The method of golf club head fabrication of claim 11, wherein the energy source is a laser.

15. The method of golf club head fabrication of claim 1, the patterning step includes direct metal laser sintering (DMLS) of the powdered layer of a selected metal.

16. The method of golf club head fabrication of claim 1, wherein at least one of the regions exhibits a metallic density in the range of 0% to 100%, the at least one region exhibiting a density different from at least one other of the regions of the plurality of regions.
